(19) United States
(12) Patent Application Publication
(10) Pub. No.: US 2018/0252047 A1
(43) Pub. Date: Sep. 6, 2018

(54) PARTIAL TRANSIENT LIQUID-PHASE BONDED POLYCRYSTALLINE DIAMOND COMPACT CUTTERS

(71) Applicant: Halliburton Energy Services, Inc., Houston, TX (US)

(72) Inventors: Grant O. COOK, III, Spring, TX (US); Gagan SAINI, The Woodlands, TX (US); William Brian ATKINS, Houston, TX (US)

(73) Assignee: Halliburton Energy Services, Inc., Houston, TX (US)

(21) Appl. No.: 15/756,566

(22) PCT Filed: Oct. 2, 2015
(86) PCT No.: PCT/US15/53628

§ 371 Date: Feb. 28, 2018

(51) Int. Cl. E21B 10/573; B22F 7/06; B23K 1/00; E21B 10/55; C22C 26/00

(52) U.S. Cl. CPC E21B 10/5735; B22F 7/064; B22F 2005/001; E21B 10/55; C22C 26/00; B23K 1/00

(57) ABSTRACT

Bonding polycrystalline diamond compacts to hard composite substrates to produce polycrystalline diamond compact (PDC) cutters may be achieved with a partial transient liquid-phase (PTLP) bonding method that uses lower temperatures than comparable brazing methods. For example, an interlayer bonding structure may be positioned between a polycrystalline diamond compact and a hard composite substrate and heated to a bonding temperature to achieve the PTLP bonding between the polycrystalline diamond compact and the hard composite substrate. An exemplary interlayer bonding structure includes a refractory layer between two outer layers.

### BACKGROUND

The present application relates to securing polycrystalline diamond to hard composite substrates to produce polycrystalline diamond compacts.

Drill bits and components thereof are often subjected to extreme conditions while drilling, such as high temperatures, high pressures, and contact with abrasive surfaces. Polycrystalline diamond compact (PDC) cutters are often positioned around a drill bit body to directly contact and cut the formation as the bit is rotated while drilling. Polycrystalline diamond compacts have beneficial properties for this purpose, such as wear resistance, hardness, and high thermal conductivity that enhance the lifetime of the drill bit.

A PDC cutter is commonly formed in a single high-pressure, high-temperature (HPHT) press cycle. First, diamond particles are placed together with a hard composite substrate in a press. During the HPHT press cycle, the diamond particles are sintered, and a so-called catalyzing material facilitates both the bonding between the diamond particles to form a polycrystalline diamond table and to attach the polycrystalline diamond table to the hard composite substrate. In most of the cases, the hard composite substrate provides a source for the catalyzing material (e.g., cobalt, nickel, iron, Group VIII elements, and any alloy thereof) to facilitate bonding between the diamond particles. For example, when cobalt-cemented tungsten carbide is the hard composite substrate, a cobalt catalyzing material may melt and infiltrate the interstitial spaces of the diamond particles. In some instances, catalyzing material may also be mixed with the diamond particles before sintering.

Immediately after the polycrystalline diamond table is formed, some catalyzing material typically remains within the interstitial spaces between the fused diamond particles. The residual catalyzing material in the polycrystalline diamond compact can cause or facilitate degradation of the polycrystalline diamond table. To mitigate these effects, a PDC is often leached to remove at least some of the catalyzing material from the interstitial spaces of the polycrystalline diamond compact near the working surface.

In some manufacturing process, the polycrystalline diamond table may be removed from the hard composite substrate so that the entire diamond table may be treated to remove some or all of the catalyzing material. Then, the polycrystalline diamond table may be re-attached (e.g., via brazing) to another hard composite substrate to form a PDC having some or all of the catalyzing material removed. This thorough approach to leaching and then re-attaching the diamond table may result in a thermally stable polycrystalline (TSP) diamond compact.

The quality and lifetime of the polycrystalline diamond increase with greater removal of the catalyzing material. However, the production of TSP diamond compacts typically takes days and uses harsh chemicals like strong acids at elevated temperatures. Also, the removal of the catalyzing material from the polycrystalline diamond generally reduces the wettability of the diamond compact and the resulting bond strength of the assembled PDC cutter.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a cross-sectional side view of a configuration of an interlayer bonding structure, polycrystalline diamond compact, and hard composite substrate suitable for producing a PDC cutter.

FIG. 2 is a cross-sectional side view of an exemplary PDC cutter formed from the configuration of FIG. 1.

FIG. 3 is a cross-sectional side view of an exemplary PDC cutter formed from the configuration of FIG. 1.

FIG. 4 is a cross-sectional side view of an interlayer bonding structure with five layers.

FIG. 5 is a cross-sectional side view of a matrix drill bit having a matrix bit body formed of a metal-matrix composite.

FIG. 6 is an isometric view of the matrix drill bit that includes a plurality of PDC cutters.

FIG. 7 is a schematic showing a drilling assembly suitable for use in conjunction with matrix drill bits that include the PDC cutters of the present disclosure.

### DETAILED DESCRIPTION

The present application relates to securing polycrystalline diamond compacts to hard composite substrates to produce polycrystalline diamond compact (PDC) cutters. More specifically, the securing is achieved with a partial transient liquid-phase (PTLP) bonding method that uses lower temperatures than comparable brazing methods.

Systems and methods are disclosed whereby a polycrystalline diamond compact may be secured to a hard composite substrate to produce a PDC cutter using transient liquid-phase (TLP) bonding and variations thereof. Generally, TLP bonding may be considered a hybrid between brazing and diffusion bonding processes to the extent that it is distinct from either brazing or diffusion bonding individually. In one implementation of TLP bonding, an interlayer material may be positioned between refractory substrates, where the interlayer material has a lower melting temperature than both refractory substrates. The assembled interlayer material and refractory substrates (i.e., the assembly) may be heated to a temperature within a temperature range sufficient to melt the interlayer material but not the refractory substrates. The assembly may be maintained within that temperature range until the liquid phase of the interlayer material has solidified due to interdiffusion with the refractory substrates. This solidification phenomenon, caused by change in composition rather than temperature, is referred to herein as isothermal solidification. The resultant TLP bond has a melting point greater than the melting point of the interlayer material due to the diffusion that occurs during the process. The melting point increase can be on the order of hundreds of degrees centigrade with the appropriate selection of process parameters, such as interlayer thickness, composition, and bonding temperature. TLP bonding can be used to bond metallic materials due to its reliance on interdiffusion with the substrate materials.

PTLP bonding is a variation of TLP bonding typically used to bond ceramic materials. In this process, the interlayer bonding structure is multi-layered, for example, composed of three layers. In a three-layer structure, the interlayer bonding structure may include a refractory layer between two outer layers adjacent the substrates to be bonded. The outer layers may be a metal or metal alloy having a lower melting point than the refractory layer and the substrates. Upon melting the two outer layers, the outer layers serve two functions: (1) to interdiffuse with the refractory layer to induce isothermal solidification, similar to the TLP bonding process and (2) to react with each substrate to create a metal-ceramic bonding interface therewith.

The present disclosure is directed in part to methods of securing a polycrystalline diamond compact to a hard composite substrate using a variation of transient liquid-phase bonding known as partial transient liquid-phase (PTLP) bonding. PTLP may generally be used to bond two ceramic parts, and more particularly, as taught herein, to bond the hard composite substrate to a polycrystalline diamond compact. What is referred to herein as the interlayer bonding structure used in PTLP is multi-layered. In a three-layer structure, for example, the interlayer bonding structure may include a refractory layer sandwiched between two outer layers. The interlayer bonding structure may be positioned between the substrates or parts to be bonded. The bonding order of components in this example could be the hard composite substrate of the polycrystalline diamond compact, the first outer layer of the interlayer bonding structure, the refractory layer of the interlayer bonding structure, the second outer layer of the interlayer bonding structure, and the hard composite substrate. The outer layers of the interlayer bonding structure may be, for example, a metal or metal alloy having a lower melting point than each of the refractory layer and the substrates, in this example the polycrystalline diamond compact and the hard composite substrate. Upon melting, the two outer layers serve two functions: (1) each interdiffuses on one side with the refractory layer to induce isothermal solidification, similar to the TLP bonding process and (2) each reacts on the other side with the adjacent substrate, with a net effect of bonding the two components (e.g., the PDC cutter to the matrix bit body).

In one implementation, by using a PTLP bonding method, the bonding temperature may be kept below the graphitization temperature of diamond, specifically, below 1472° F., while producing a bond that has a melting point greater than 1472° F. In some embodiments, the resulting bond may have a melting point greater than 1500° F., 1600° F., or 1700° F. In yet other embodiments, the bonding temperature may be kept below 1400° F., 1300° F., or 1200° F.

FIG. 1, for example, is a cross-sectional side view of a configuration 100 of an interlayer bonding structure 102, polycrystalline diamond compact 104, and hard composite substrate 106 suitable for producing a PDC cutter, according to at least some embodiments of the present disclosure. The interlayer bonding structure 102 is positioned between the polycrystalline diamond compact 104 (which may have at least some of the catalyzing material removed) and the hard composite substrate 106 (e.g., cemented tungsten carbide). The interlayer bonding structure 102 includes a refractory layer 108 between two metal or metal alloy outer layers 110,112.

The interlayer bonding structure 102 may be positioned between the polycrystalline diamond compact 104 and the hard composite substrate 106 by a plurality of methods. For example, the interlayer bonding structure 102 may be a multi-layer foil placed on the surface of the polycrystalline diamond compact 104 or on the surface of the hard composite substrate 106 before assembling the polycrystalline diamond compact 104 and the hard composite substrate 106. Alternatively, the individual layers of the interlayer bonding structure 102 may be a foil, a paste, or a powder that are assembled in the proper order on the surface of the polycrystalline diamond compact 104, on the surface of the hard composite 210, or both to form the interlayer bonding structure 102 once the polycrystalline diamond compact 104 and the hard composite substrate 106 are assembled. Additionally, in some instances, one or more of the individual layers of the interlayer bonding structure 102 may be deposited on the surface of the polycrystalline diamond compact 104 or on the surface of the hard composite substrate 106 by sputtering, thermal spray, physical vapor deposition, chemical vapor deposition, electrolytic deposition, electroless deposition, or the like.

After the interlayer bonding structure 102 is properly positioned in the configuration 100, a selected PTLP bonding method may be used to secure the polycrystalline diamond compact 104 to the hard composite substrate 106. More specifically, the materials may be heated to bonding temperature that is (1) above the melting point of the outer layers 110,112 or above the lowest eutectic melting point of the outer layers 110,112, (2) below the melting point of the refractory layer 108, and, preferably, and (3) below the diamond graphitization temperature. The bonding temperature may range from 1000° F. to 1500° F. The interlayer bonding structures 102 are held at the bonding temperature for a time sufficient for the outer layers 110,112 to each interdiffuse on one side with the refractory layer 108 to induce isothermal solidification and each reacts on the other side with the adjacent substrate.

Heating may be performed with radiation heating, conduction heating, convection heating, radio-frequency induction heating, resistance heating, infrared heating, laser heating, electron-beam heating, or a combination thereof.

To achieve the desired bonding described herein, heating may be performed at a slow rate, especially as the temperature approaches the melting temperature of the outer layers 110,112. This may allow for the outer layers 110,112 to melt evenly and form more homogeneous bonds. In some instances, within 200° F. or less of the bonding temperature, heating may be at a rate of 3° F./min to 60° F./min. Once at the bonding temperature, the temperature may be held at the bonding temperature for 1 minute to 6 hours or more to achieve isothermal solidification of the interlayer bonding structure 102. Holding at the bonding temperature may also facilitate the formation of more homogeneous bonds.

In some instances, physical pressure (e.g., 1 kPa to 100 MPa) may also be applied to the configuration 100 in the axial direction during heating to maintain the configuration 100 in the proper position and facilitate contact during bonding. While bonding may preferably be performed at atmospheric pressure, in some instances, the bonding may be performed at reduced air pressures (e.g., 0.001 mTorr to 50 Torr). Moreover, while bonding may be performed in an air atmosphere, in some embodiments, the bonding may be performed, whether at reduced air pressure or atmospheric pressure, in an inert atmosphere that may contain gases like argon, nitrogen, helium, and the like, or mixtures thereof. Combinations of the foregoing may be implemented. For example, bonding may occur with physical pressure applied in an inert atmosphere at a reduced air pressure.

After heating to and holding at the bonding temperature, the materials may be cooled to produce the PDC cutter. In some embodiments, cooling may proceed at a rate of 3° F./min to 60° F./min within 200° F. or less of the bonding temperature and then, optionally, at a faster rate, as desired.

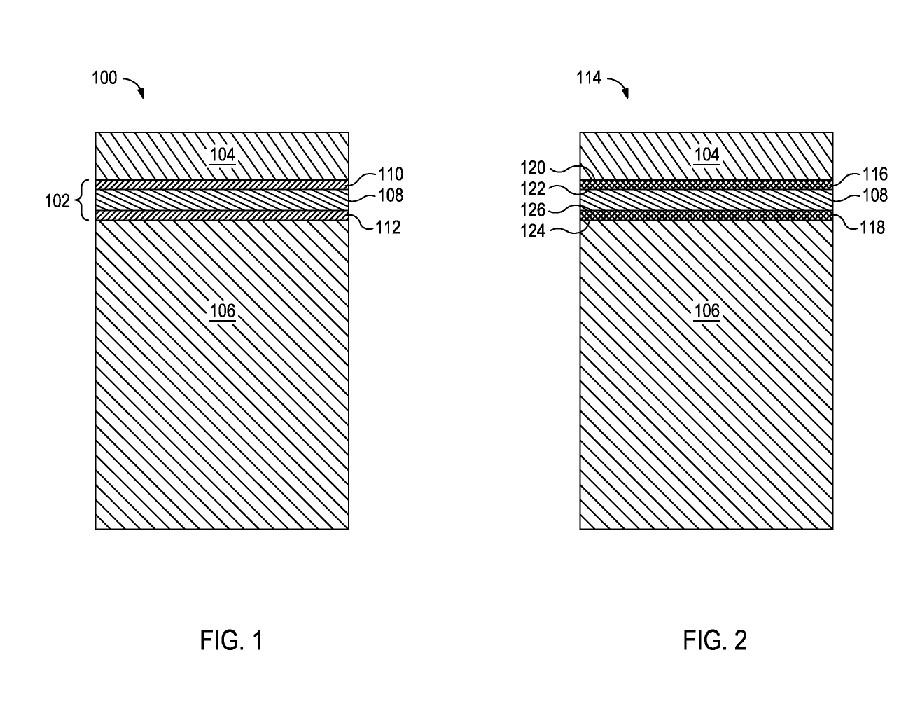

FIG. 2 is a cross-sectional side view after bonding of an exemplary PDC cutter 114 formed from the configuration 100 of FIG. 1 according to at least some embodiments of the present disclosure. A first bond 116 may be formed between the polycrystalline diamond compact 104 and the refractory layer 108, and a second bond 118 may be formed between the hard composite substrate 106 and the refractory layer 108. The bonds 116,118 have a melting point greater than the melting point of the two outer layers 110,112.

Because the outer layers 110,112 of FIG. 1 react differently with the abutting substrates, the bonds 116,118 formed comprise different portions. As used herein, the term “bonding portion” refers to a portion of a bond. The first bond 116 includes a metal-ceramic bonding portion 120 with the polycrystalline diamond compact 104 and a TLP bonding portion 122 with the refractory layer 108. The second bond 118 includes a metal-ceramic bonding portion 124 with the hard composite substrate 106 and a TLP bonding portion 126 with the refractory layer 108.

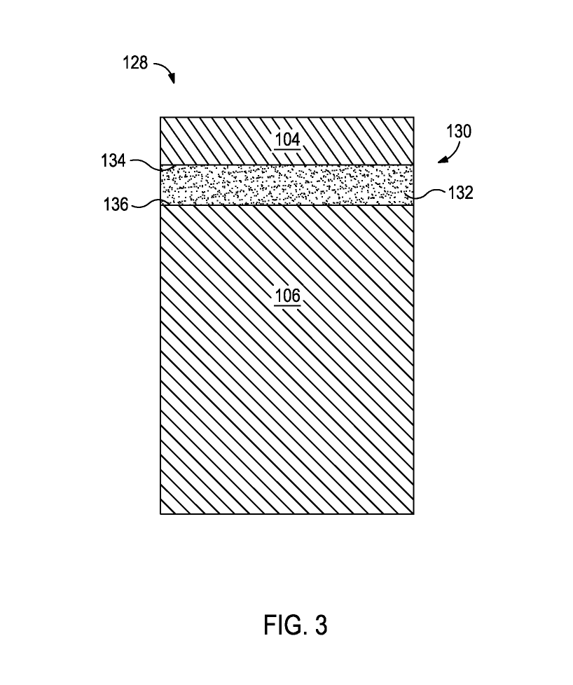

FIG. 3 is a cross-sectional side view after bonding of an exemplary PDC cutter 128 formed from the configuration 100 of FIG. 1 according to at least alternate embodiments of the present disclosure. In FIG. 3, the refractory layer 108 and outer layers 110,112 of FIG. 1 are sufficiently sized (e.g., sufficiently thin) such that a bond 130 is formed between the polycrystalline diamond compact 104 and the hard composite substrate 106 that no longer contains the refractory layer 108 as a distinct layer. That is, during heating, the outer layers 110,112 diffuse into the refractory layer 108 such that a resulting TLP bonding portion 132 comprises the majority of the bond 130 where the refractory layer 108 was. As illustrated, the bond 130 is composed of (1) a metal-ceramic bonding portion 134 with the polycrystalline diamond compact 104 that transitions to (2) the TLP bonding portion 132 that transitions to (3) a metal-ceramic bonding portion 136 with the hard composite substrate 106. The TLP bonding portion 132 has a melting point greater than the melting point of the two outer layers 110,112 and the bonding temperature.

The bonding portions 120,122,124,126 of the PDC cutter 114 of FIG. 2 and the bonding portions 132,134,136 of PDC cutter 128 of FIG. 3 are illustrated as distinctly defined portions of their respective bonds, which may occur in some instances. In other instances, the bonding portions 120,122,124,126,132,134,136 may not be distinctly defined portions of their respective bonds, but rather each of the bonding portions 120,122,124,126,132,134,136 may independently have a thickness associated therewith as a result of the interdiffusion and/or reaction having occurred the abutting substrate. Further, the bonds 116,118 of the PDC cutter 114 of FIG. 2 may be composed essentially of their respective bonding portions 120,122,124,126 and a transition between their respective bonding portions 120,122,124,126. Due to the significant amount of diffusion that may occur during PTLP bonding, the TLP bonding portions 122,126,132 may not be distinguishable by microscopy or composition analysis.

The illustrated examples in FIGS. 1-3 include, and are otherwise based on, a three-layer interlayer bonding structure 102. In some embodiments, however, the interlayer bonding structure 102 may have more than three layers. Accordingly, as used herein, the term “interlayer bonding structure” may refer to a layered structure comprising a first outer layer, a second outer layer, and at least one refractory layer between the first and second outer layers. Such a description does not preclude additional layers between the first and second outer layers.

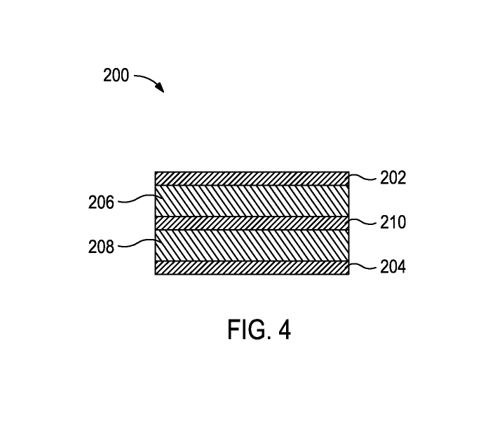

FIG. 4, for example, is a cross-sectional side view of an exemplary interlayer bonding structure 200 that includes five layers. As illustrated, the interlayer bonding structure 200 may include two outer layers 202,204 and two refractory layers 206,208 positioned therebetween. An intermediate layer 210 between the two refractory layers 206,208 may be composed of materials that directly melt or that form eutectic melts with the abutting refractory layers 206,208, examples of which are described further herein.

Upon heating to the bonding temperature, the intermediate layer 210 may form a TLP bond, braze bond, or diffusion bond between the two refractory layers 206,208. The interlayer bonding structure 200 with five layers or other interlayer bonding structure configurations with more layers may be used in place of interlayer bonding structure 102 of FIG. 1.

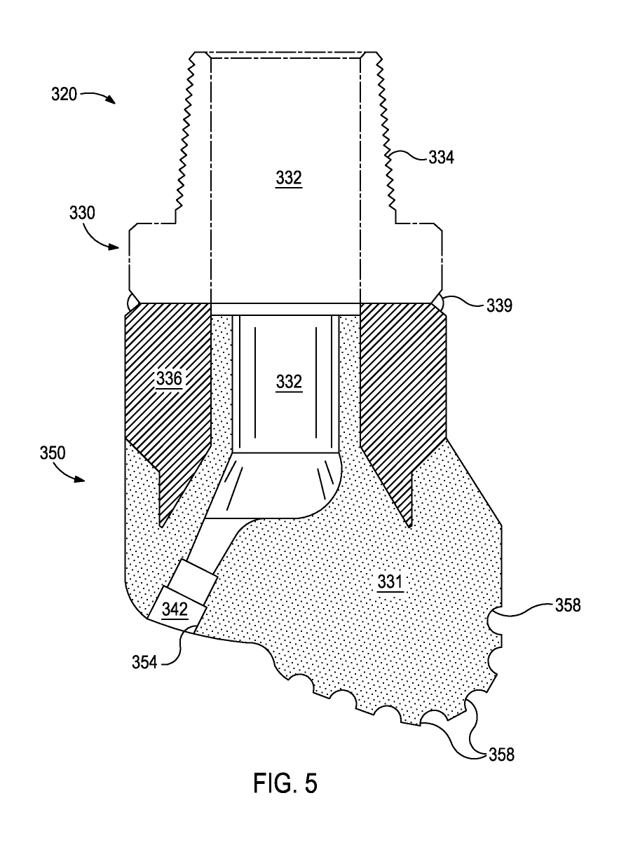

FIG. 5 is a cross-sectional side view of a matrix drill bit 320 having a matrix bit body 350 formed by a metal-matrix composite 331 (e.g., tungsten carbide reinforcing particles dispersed in a binder alloy). As used herein, the term “matrix drill bit” encompasses rotary drag bits, drag bits, fixed-cutter drill bits, and any other drill bit having a matrix bit body and capable of incorporating the teachings of the present disclosure.

For embodiments such as those shown in FIG. 5, the matrix drill bit 320 may include a metal shank 330 with a mandrel or metal blank 336 securely attached thereto (e.g., at weld location 339). The metal blank 336 extends into matrix bit body 350. The metal shank 330 includes a threaded connection 334 distal to the metal blank 336.

The metal shank 330 and metal blank 336 are generally cylindrical structures that at least partially define corresponding fluid cavities 332 that fluidly communicate with each other. The fluid cavity 332 of the metal blank 336 may further extend longitudinally into the matrix bit body 350. At least one flow passageway (shown as flow passageway 342) may extend from the fluid cavity 332 to exterior portions of the matrix bit body 350. Nozzle openings 354 may be defined at the ends of the flow passageways 342 at the exterior portions of the matrix bit body 350.

A plurality of indentations or pockets 358 are formed in the matrix bit body 350 and are shaped or otherwise configured to receive PDC cutters formed by the methods described herein.

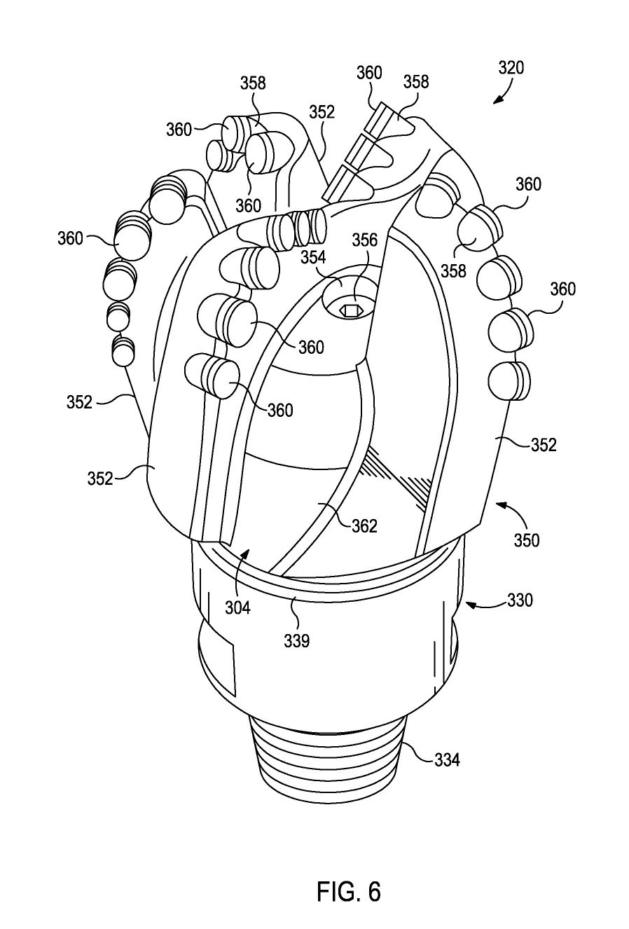

FIG. 6 is an isometric view of the matrix drill bit that includes a plurality of PDC cutters 360 according to at least some embodiments of the present disclosure. The PDC cutters 360 may be the same as or similar to the PDC cutter 114 of FIG. 2 or the PDC cutter 128 of FIG. 3. As illustrated, the matrix drill bit 320 includes the metal blank 336 and the metal shank 330, as generally described above with reference to FIG. 5.

The matrix bit body 350 includes a plurality of cutter blades 352 formed on the exterior of the matrix bit body 350. Cutter blades 352 may be spaced from each other on the exterior of the matrix bit body 350 to form fluid flow paths or junk slots 362 therebetween.

As illustrated, the plurality of pockets 358 may be formed in the cutter blades 352 at selected locations. A PDC cutter 360 may be securely mounted (e.g., via brazing) in each pocket 358 to engage and remove portions of a subterranean formation during drilling operations. More particularly, each PDC cutter 360 may scrape and gouge formation materials from the bottom and sides of a wellbore during rotation of the matrix drill bit 320 by an attached drill string. A nozzle 356 may be positioned in each nozzle opening 354.

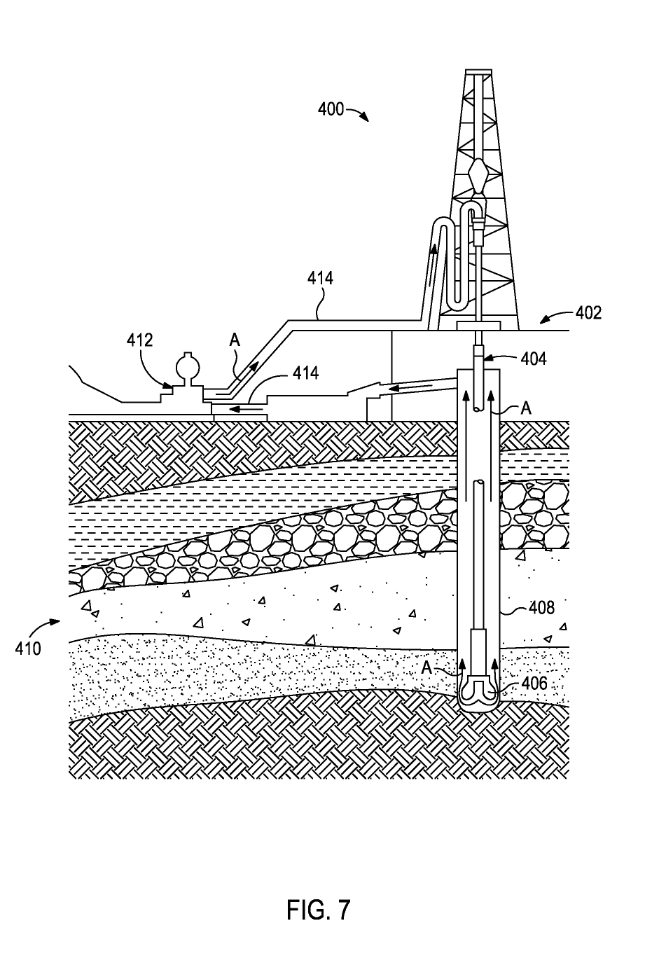

FIG. 7 is a schematic showing one example of a drilling assembly 400 suitable for use in conjunction with matrix drill bits that include PDC cutters manufactured using the methods and principles of the present disclosure (e.g., PDC cutter 114 of FIG. 2 or PDC cutter 128 of FIG. 3). It should be noted that while FIG. 7 generally depicts a land-based drilling assembly, those skilled in the art will readily recognize that the principles described herein are equally applicable to subsea drilling operations that employ floating or sea-based platforms and rigs, without departing from the scope of the disclosure.

The drilling assembly 400 includes a drilling platform 402 coupled to a drill string 404. The drill string 404 may include, but is not limited to, drill pipe and coiled tubing, as generally known to those skilled in the art apart from the particular teachings of this disclosure. A matrix drill bit 406 according to the embodiments described herein is attached to the distal end of the drill string 404 and is driven either by a downhole motor and/or via rotation of the drill string 404 from the well surface. As the drill bit 406 rotates, it creates a wellbore 408 that penetrates the subterranean formation 410. The drilling assembly 400 also includes a pump 412 that circulates a drilling fluid through the drill string (as illustrated as flow arrows A) and other pipes 414.

One skilled in the art would recognize the other equipment suitable for use in conjunction with drilling assembly 400, which may include, but is not limited to, retention pits, mixers, shakers (e.g., shale shaker), centrifuges, hydrocyclones, separators (including magnetic and electrical separators), desilters, desanders, filters (e.g., diatomaceous earth filters), heat exchangers, and any fluid reclamation equipment. Further, the drilling assembly may include one or more sensors, gauges, pumps, compressors, and the like.

The hard composite substrates described herein may include cemented carbide material. Exemplary carbides may include, but are not limited to, silicon carbides, boron carbides, cubic boron carbides, molybdenum carbides, titanium carbides, tantalum carbides, niobium carbides, chromium carbides, vanadium carbides, iron carbides, zirconium carbides, hafnium carbides, tungsten carbides (e.g., macrocrystalline tungsten carbide, cast tungsten carbide, crushed sintered tungsten carbide, carburized tungsten carbide, etc.), and any mixture thereof. Suitable binder materials include, but are not limited to, cobalt, nickel, iron, copper, manganese, zinc, titanium, tantalum, niobium, molybdenum, chromium, any alloy thereof, and any combination thereof. In some embodiments, the hard composite substrate 106 may also be coated with a material to increase certain properties, such as hardness or compact life. Suitable coating materials include titanium nitride, titanium carbide, titanium carbide-nitride, and titanium aluminum nitride, and the like, and any combination thereof.

The refractory layer of the interlayer bonding structures described herein may be composed of any metal or metal alloy with a melting point above the selected bonding temperature. For example, for a bonding temperature of 1472° F., suitable refractory layer materials include tungsten, rhenium, osmium, tantalum, molybdenum, niobium, iridium, boron, ruthenium, hafnium, rhodium, vanadium, chromium, zirconium, platinum, titanium, lutetium, palladium, thulium, scandium, iron, yttrium, erbium, cobalt, holmium, nickel, dysprosium, silicon, terbium, gadolinium, beryllium, manganese, promethium, copper, samarium, gold, neodymium, silver, germanium, praseodymium, lanthanum, calcium, ytterbium, europium, arsenic, and the like, any combination thereof, and any alloy thereof. Additionally, for a bonding temperature of 1200° F., suitable refractory layer materials include the previously mentioned materials for the refractory layer in addition to cerium, strontium, barium, and aluminum, any combination thereof, and any alloy thereof.

The refractory layer of the interlayer bonding structures described herein may have a thickness ranging from 10 microns to 1000 microns. When forming a PDC cutter, the refractory layer may preferably have a thickness ranging from 25 microns to 150 microns.

The outer layers of the interlayer bonding structures described herein may each independently be composed of materials that directly melt or that form eutectic melts with the refractory layer 108. Suitable materials for outer layers that may directly melt include cerium, strontium, barium, aluminum, magnesium, antimony, tellurium, zinc, lead, cadmium, thallium, bismuth, tin, selenium, lithium, indium, iodine, sulfur, sodium, potassium, phosphorus, rubidium, gallium, cesium, and the like, any combination thereof, and any alloy thereof. Suitable materials for outer layers that may form a eutectic melt with the refractory layer include all binary systems wherein both elements have higher melting points than the bonding temperature and the lowest eutectic melting point is below the bonding temperature, any combination thereof, and any alloy thereof. These binary systems may comprise any two elements from the materials listed above for the refractory layer 108.

The outer layers of the interlayer bonding structures described herein may have a thickness ranging from 0.1 micron to 10 microns.

Suitable materials for an intermediate layer of the interlayer bonding structures described herein may directly melt and include cerium, strontium, barium, aluminum, magnesium, antimony, tellurium, zinc, lead, cadmium, thallium, bismuth, tin, selenium, lithium, indium, iodine, sulfur, sodium, potassium, phosphorus, rubidium, gallium, cesium, and the like, any combination thereof, and any alloy thereof. Suitable materials for intermediate layer 210 that may form a eutectic melt with the refractory layers 206,208 include all binary systems wherein both elements have higher melting points than the bonding temperature and the lowest eutectic melting point is below the bonding temperature, any combination thereof, and any alloy thereof. These binary systems may comprise any two elements from the materials listed above for the refractory layers.

The intermediate layer of the interlayer bonding structure may have a thickness ranging from 0.1 micron to 10 microns.

Embodiments described herein may include Embodiments A, B, C, D, or E.

Embodiment A is a method that includes positioning an interlayer bonding structure between a polycrystalline diamond compact and a hard composite substrate, the interlayer bonding structure comprising a first outer layer adjacent the polycrystalline diamond compact, a second outer layer adjacent the hard composite substrate, and a refractory layer between the first and second outer layers, wherein the first and second outer layers have melting points lower than a melting point of the refractory layer; heating the interlayer bonding structure to a bonding temperature within a temperature range above the melting points of the first and second outer layers and below the melting point of the refractory layer; and maintaining the bonding temperature within the temperature range for a period of time sufficient to isothermally solidify the outer layers with the refractory layer and to react the outer layers with the polycrystalline diamond compact and the hard composite substrate.

Optionally, Embodiment A may further include one or more of the following elements: Element 1: wherein the refractory layer is a first refractory layer adjacent to the first outer layer and a second refractory layer is adjacent to the second outer layer, wherein the interlayer bonding structure has an interior layer between the first and second refractory layers, and wherein maintaining the bonding temperature causes the intermediate layer to react or isothermally solidify with the first and second refractory layers; Element 2: wherein the at least one refractory layer is a single refractory layer that between the first and the second outer layers; Element 3: wherein isothermally solidifying the outer layers with the refractory layer and reacting the outer layers with the polycrystalline diamond compact and the hard composite substrate forms: a first bond between the polycrystalline diamond compact and the refractory layer, wherein the first bond has a melting point above the melting points of the first and second outer layers and comprises a first metal-ceramic bonding portion with the polycrystalline diamond compact and a first transient liquid phase (TLP) bonding portion with the refractory layer, and a second bond between the hard composite substrate and the refractory layer, wherein the second bond comprises a second metal-ceramic bonding portion with the hard composite substrate and a second TLP bonding portion with the refractory layer; Element 4: wherein isothermally solidifying the outer layers with the refractory layer and reacting the outer layers with the polycrystalline diamond compact and the hard composite substrate forms: a bond between the polycrystalline diamond compact and the hard composite substrate, wherein the bond transitions from a first metal-ceramic bonding portion with the polycrystalline diamond compact, to a transient liquid phase bonding portion, and to a second metal-ceramic bonding portion with the hard composite substrate; Element 5: the method further including maintaining the bonding temperature of the interlayer bonding structure for 1 minute to 6 hours; Element 6: the method further including applying pressure to at least one of the polycrystalline diamond compact or the hard composite substrate to maintain a position of the interlayer bonding structure while heating the interlayer bonding structure; Element 7: wherein heating the interlayer bonding structure involves heating at a rate of 3° F./min to 60° F./min within 200° F. or less of the bonding temperature; Element 8: wherein heating the interlayer bonding structure is performed in an inert atmosphere; Element 9: wherein heating the interlayer bonding structure is performed below atmospheric pressure; Element 10: the method further including cooling the interlayer bonding structure at a rate of 3° F./min to 60° F./min within 200° F. or less of the bonding temperature; Element 11: the method further including assembling at least a portion of the interlayer bonding structure on the hard composite substrate; Element 12: the method further including assembling at least a portion of the interlayer bonding structure on the MMC; Element 13: the method further including applying the first outer layer to the hard composite substrate by one of: sputtering, thermal spray, physical vapor deposition, chemical vapor deposition, electrolytic deposition, or electroless deposition; and Element 14: the method further including applying the second outer layer to the MMC by one of: sputtering, thermal spray, physical vapor deposition, chemical vapor deposition, electrolytic deposition, or electroless deposition. Exemplary combinations of the foregoing elements may include, but are not limited to, Element 1 or Element 2 (optionally with Element 3 or Element 4) in combination with one or more of Elements 5-10; Element 5 in combination with one or more of Elements 6-10; Element 6 in combination with one or more of Elements 7-10; Element 7 in combination with one or more of Elements 8-10; Element 8 in combination with one or more of Elements 9-10; Element 9 in combination with Element 10; one or more of Elements 11-14 in combination with any of the foregoing; two or more of Elements 11-14 in combination; and one or more of Elements 11-14 in combination with one or more of Elements 1-10.

Embodiment B is a PDC cutter that includes a polycrystalline diamond compact bonded to a refractory layer at a first bond, wherein the first bond comprises a first metal-ceramic bonding portion with the polycrystalline diamond compact and a first transient liquid phase bonding portion with the refractory layer; and a hard composite substrate bonded at a second bond to a side of the refractory layer opposing the first bond, wherein the second bond comprises a second metal-ceramic bonding portion with the hard composite substrate and a second transient liquid phase bonding portion with the refractory layer.

Embodiment C is a PDC cutter that includes a polycrystalline diamond compact bonded to a hard composite substrate bonded at a bond that transitions from a first metal-ceramic bonding portion with the polycrystalline diamond compact to a transient liquid phase bonding portion to a second metal-ceramic bonding portion with the hard composite substrate.

Embodiment D is a drilling assembly that includes a drill string extending into a wellbore; a pump fluidly connected to the drill string and configured to circulate a drilling fluid into the drill string and through the wellbore; and a drill bit attached to an end of the drill string, the drill bit having a matrix bit body and a plurality of PDC cutters according to Embodiments B and/or C or formed by Embodiment A coupled to an exterior portion of the matrix bit body.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method of securing a polycrystalline diamond compact to a hard composite substrate, the method comprising:
positioning an interlayer bonding structure between the polycrystalline diamond compact and the hard composite substrate, the interlayer bonding structure comprising a first outer layer adjacent the polycrystalline diamond compact, a second outer layer adjacent the hard composite substrate, and a refractory layer between the first and second outer layers, wherein the first and second outer layers have melting points lower than a melting point of the refractory layer;
heating the interlayer bonding structure to a bonding temperature within a temperature range above the melting points of the first and second outer layers and below the melting point of the refractory layer; and
maintaining the bonding temperature within the temperature range for a period of time sufficient to isothermally solidify the outer layers with the refractory layer and to react the outer layers with the polycrystalline diamond compact and the hard composite substrate.

2. The method of claim 1, wherein isothermally solidifying the outer layers with the refractory layer and reacting the outer layers with the polycrystalline diamond compact and the hard composite substrate forms: a first bond between the polycrystalline diamond compact and the refractory layer, wherein the first bond has a melting point above the melting points of the first and second outer layers and comprises a first metal-ceramic bonding portion with the polycrystalline diamond compact and a first transient liquid phase (TLP) bonding portion with the refractory layer, and a second bond between the hard composite substrate and the refractory layer, wherein the second bond comprises a second metal-ceramic bonding portion with the hard composite substrate and a second TLP bonding portion with the refractory layer.

3. The method of claim 1, wherein isothermally solidifying the outer layers with the refractory layer and reacting the outer layers with the polycrystalline diamond compact and the hard composite substrate forms: a bond between the polycrystalline diamond compact and the hard composite substrate, wherein the bond transitions from a first metal-ceramic bonding portion with the polycrystalline diamond compact, to a transient liquid phase bonding portion, and to a second metal-ceramic bonding portion with the hard composite substrate.

4. The method of claim 1, wherein the refractory layer is a single refractory layer that between and abutting the first and the second outer layers.

5. The method of claim 1, wherein the refractory layer is a first refractory layer adjacent to the first outer layer and a second refractory layer is adjacent to the second outer layer, wherein the interlayer bonding structure has an interior layer between the first and second refractory layers, and wherein maintaining the bonding temperature causes the intermediate layer to react or isothermally solidify with the first and second refractory layers.

6. The method of claim 1 further comprising:
maintaining the bonding temperature within the temperature range for 1 minute to 6 hours.

7. The method of claim 1 further comprising:
applying pressure to at least one of the polycrystalline diamond compact or the hard composite substrate to maintain a position of the interlayer bonding structure or to facilitate contact during bonding while heating and/or cooling the interlayer bonding structure.

8. The method of claim 1, wherein heating the interlayer bonding structure involves heating at a rate of 3° F./min to 60° F./min within 200° F. or less of the bonding temperature.

9. The method of claim 1, wherein heating the interlayer bonding structure is performed in an inert atmosphere.

10. The method of claim 1, wherein heating the interlayer bonding structure is performed below atmospheric pressure.

11. The method of claim 1 further comprising:
cooling the interlayer bonding structure at a rate of 3° F./min to 60° F./min within 200° F. or less of the bonding temperature.

12. The method of claim 1 further comprising:
assembling at least a portion of the interlayer bonding structure on the polycrystalline diamond compact.

13. The method of claim 1 further comprising:
assembling at least a portion of the interlayer bonding structure on the hard composite substrate.

14. The method of claim 1 further comprising:
applying the first outer layer to the polycrystalline diamond compact by one of: sputtering, thermal spray, physical vapor deposition, chemical vapor deposition, electrolytic deposition, or electroless deposition.

15. The method of claim 1 further comprising:
applying the second outer layer to the hard composite substrate by one of: sputtering, thermal spray, physical vapor deposition, chemical vapor deposition, electrolytic deposition, or electroless deposition.

16. A polycrystalline diamond compact cutter comprising:
a polycrystalline diamond compact bonded to a refractory layer at a first bond, wherein the first bond comprises a first metal-ceramic bonding portion with the polycrystalline diamond compact and a first transient liquid phase bonding portion with the refractory layer; and
a hard composite substrate bonded at a second bond to a side of the refractory layer opposing the first bond, wherein the second bond comprises a second metal-ceramic bonding portion with the hard composite substrate and a second transient liquid phase bonding portion with the refractory layer.

17. A drilling assembly comprising:
a drill string extending into a wellbore;
a pump fluidly connected to the drill string and configured to circulate a drilling fluid into the drill string and through the wellbore; and
a drill bit attached to an end of the drill string, the drill bit having a matrix bit body and a plurality of polycrystalline diamond compact cutters according to claim 16 coupled to an exterior portion of the matrix bit body.

18. A polycrystalline diamond compact cutter comprising:
a polycrystalline diamond compact bonded to a hard composite substrate bonded at a bond that transitions from a first metal-ceramic bonding portion with the polycrystalline diamond compact to a transient liquid phase bonding portion to a second metal-ceramic bonding portion with the hard composite substrate.

19. A drilling assembly comprising:
a drill string extending into a wellbore;
a pump fluidly connected to the drill string and configured to circulate a drilling fluid into the drill string and through the wellbore; and
a drill bit attached to an end of the drill string, the drill bit having a matrix bit body and a plurality of polycrystalline diamond compact cutters according to claim 18 coupled to an exterior portion of the matrix bit body.
